(19) United States
(12) Patent Application Publication
(10) Pub. No.: US 2014/0301107 A1
(43) Pub. Date: Oct. 9, 2014

(54) LIGHTING APPARATUS AND DISPLAY APPARATUS

(71) Applicant: Panasonic Corporation, Osaka (JP)

(72) Inventors: Tomonori MIZUTANI, Kanagawa (JP); Hisanori SASAKI, Osaka (JP); Yoshikazu YAMANO, Osaka (JP)

(21) Appl. No.: 14/309,218

(22) Filed: Jun. 19, 2014

Related U.S. Application Data
(63) Continuation of application No. PCT/JP2013/007132, filed on Dec. 4, 2013.

(30) Foreign Application Priority Data
Mar. 11, 2013 (JP) 2013-047494

(51) Int. Cl. F21V 8/00

(52) U.S. Cl. CPC G02B 6/0091
USPC 362/612

(57) ABSTRACT

A lighting apparatus of the present disclosure includes: a light source device having one or more light emitting diodes; a board on which the light source device is provided; a light guide plate having an entrance surface facing a light exit surface of the light source device to allow entry of light therefrom, and a light emission surface which emits the light having entered through the entrance surface, the light guide plate configured to propagate the light having entered through the entrance surface and emit the light through the light emission surface; and an engagement member fixed on the board and engaging the board with the light guide plate, the engagement member configured to prevent relative motion, between the board and an engaged portion of the light guide plate engaged with the board, in a direction in which the light exit surface and the entrance surface face each other.

### BACKGROUND

1. Field

The present disclosure relates to a lighting apparatus including one or more light emitting diodes and a light guide plate which light from these light emitting diodes enters, and to a display apparatus using the lighting apparatus.

2. Description of the Related Art

In recent years, a lighting apparatus using a light emitting diode (hereinafter, may be referred to as an LED) as a light source without using mercury is being developed and put into practical use. For example, a liquid crystal display apparatus using an LED as a light source is widely utilized as a flat panel display for a liquid crystal television, a monitor, a mobile phone, and the like. Such a liquid crystal display apparatus is described in Patent Literature 1 (International Publication No. 2011/10492) or the like, for example.

In the liquid crystal display apparatus as described above, an LED may be disposed in the vicinity of the outer circumference of the liquid crystal display apparatus. In the case of disposing an LED at the outer circumference, a diffusing member for a light source, called a light guide plate, is needed in order that a display portion of the liquid crystal display apparatus is uniformly illuminated by the light source.

### CITATION LIST

[PLT 1] International Publication No. 2011/10492

[PLT 2] Japanese Laid-Open Patent Publication No. 2009-289663

[PLT 3] Japanese Laid-Open Patent Publication No. 2009-109942

[PLT 4] Japanese Laid-Open Patent Publication No. 2004-273185

[PLT 5] Japanese Laid-Open Patent Publication No. 2011-150264

[PLT 6] Specification of U.S. Pat. No. 7,599,020

[PLT 7] Specification of U.S. Patent Application Publication No. 2012/0182497

[PLT 8] Specification of U.S. Pat. No. 7,750,990

### SUMMARY

However, in the liquid crystal display apparatus using the light guide plate as shown in Patent Literature 1, the light guide plate and an LED board are respectively positioned by other members. Therefore, there is a problem that, when the light guide plate is deformed by thermal expansion or hygroscopic expansion, the positional relationship between an exit surface of an LED and an entrance surface of the light guide plate is relatively changed.

In recent years, a slim frame model is required based on desire relevant to design. In order to realize a slim frame structure, it is necessary to make the exit surface of an LED and the entrance surface of the light guide plate closer to each other than in conventional case. The problem in this case is that the LED is destroyed by expansion of the light guide plate. Conventionally, in order to solve this problem, expansion of the light guide plate is suppressed by using a pin or the like, but in this case, the light guide plate is bent, resulting in a problem of luminance unevenness. The luminance unevenness is conspicuously seen when the entire screen is displayed at white tone or a tone close to white tone, for example. In addition, the bending of the light guide plate increases as the size of the display apparatus increases, and along with this, the luminance unevenness remarkably appears.

Therefore, an object of the present disclosure is to provide a lighting apparatus and a display apparatus that can keep constant the relative positional relationship between an entrance surface of a light guide plate and an exit surface of a light emitting diode.

A lighting apparatus of the present disclosure includes: a light source device having one or more light emitting diodes; a board on which the light source device is provided; a light guide plate having an entrance surface facing a light exit surface of the light source device via a given distance such that light emitted from the light exit surface of the light source device enters the entrance surface, and a light emission surface which emits the light having entered through the entrance surface, the light guide plate configured to propagate the light having entered through the entrance surface and emit the light through the light emission surface; and an engagement member fixed on the board and engaging the board with the light guide plate, the engagement member configured to prevent relative motion, between the board and an engaged portion of the light guide plate engaged with the board, in a direction in which the light exit surface of the light source device and the entrance surface of the light guide plate face each other.

According to the present disclosure, since the LED board is engaged with the light guide plate by the engagement member, during expansion of the light guide plate, displacement of the LED board in the facing direction relative to the engaged portion of the light guide plate is prevented, so that the LED board is carried together with the light guide plate by the motion of the light guide plate. As a result, the relative positional relationship between the entrance surface of the light guide plate and the exit surface of the light emitting diode (the distance between the entrance surface of the light guide plate and the exit surface of the light emitting diode) can be kept constant.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is an exploded perspective view for explaining a lighting apparatus and a liquid crystal display apparatus according to the present disclosure;

FIG. 2 is an A-A sectional view of the lighting apparatus and the liquid crystal display apparatus shown in FIG. 1;

FIG. 3 is a perspective view showing the characteristic structure of a light source unit according to the present disclosure, in which (a) is a perspective view showing the entire light source unit, (b) is an enlarged view of an upper left part of the light source unit, and (c) is an enlarged view of a lower left part of the light source unit;

FIG. 4 is a perspective view showing the characteristic structure of the light source unit according to the present disclosure, in which (a) is a front view showing the entire light source unit, (b) is an enlarged view of an upper left part of the light source unit, and (c) is an enlarged view of a lower left part of the light source unit;

FIG. 5 is an exploded perspective view for explaining a lighting apparatus and a liquid crystal display apparatus without a unified-motion mechanism;

FIG. 6 is an A-A sectional view of the lighting apparatus and the liquid crystal display apparatus shown in FIG. 5;

FIG. 7 is a sectional view of liquid crystal display apparatuses showing an effect of the present disclosure, in which (a) is a sectional view of the liquid crystal display apparatus without the unified-motion mechanism and (b) is a sectional view of the liquid crystal display apparatus in the case of using the present disclosure;

FIG. 8 is a view showing a first modification of the present disclosure, in which (a) is a perspective view of the entire light source unit, (b) is an enlarged view of an upper left part of the light source unit, and (c) is an enlarged view of a lower left part of the light source unit;

FIG. 9 is a perspective view showing a second modification of the present disclosure; and

FIG. 10 is a perspective view showing a third modification of the present disclosure.

### DETAILED DESCRIPTION

The lighting apparatus according to the present disclosure may have a second configuration that, in the lighting apparatus having the aforementioned configuration (referred to as a first configuration), the engagement member is a part of the board, that is engaged with a cutout formed in the light guide plate.

The lighting apparatus according to the present disclosure may have a third configuration that, in the lighting apparatus having the first configuration, the engagement member is a pin that is engaged with a cutout or a hole formed in the light guide plate.

The lighting apparatus according to the present disclosure may have a fourth configuration that, in the lighting apparatus having the first configuration, the board has a portion that covers an interspace between the light exit surface of the light source device and the entrance surface of the light guide plate from a front surface side.

The lighting apparatus according to the present disclosure may have a fifth configuration that, in the lighting apparatus having any one of the first to fourth configurations, the engaged portion of the light guide plate is located at a side close to the entrance surface of the light guide plate, as seen from the facing direction.

The lighting apparatus according to the present disclosure may have a sixth configuration that, in the lighting apparatus having the first configuration, the engagement member is located separately from the light guide plate by a gap provided at the engaged portion in a direction perpendicular to the facing direction on a plane of the light guide plate, the gap affording relative motion between the board and the light guide plate in the perpendicular direction within the gap.

The lighting apparatus according to the present disclosure may have a seventh configuration that, in the lighting apparatus having the first configuration, the board is a board formed by laminating a polyimide layer and a copper foil, in this order, on an aluminum substrate.

In addition, the present disclosure provides a display apparatus including each lighting apparatus.

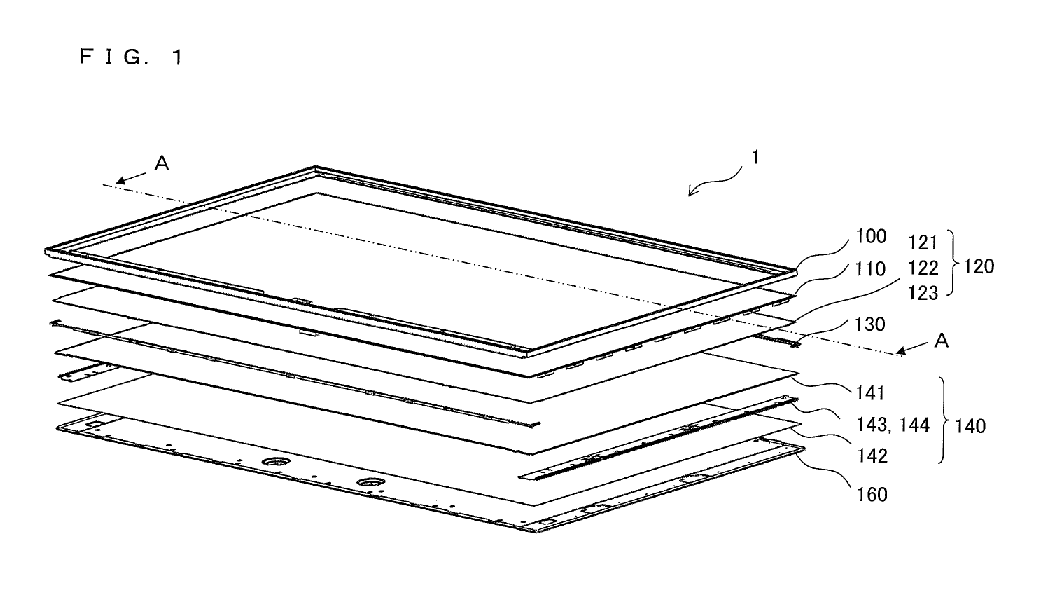

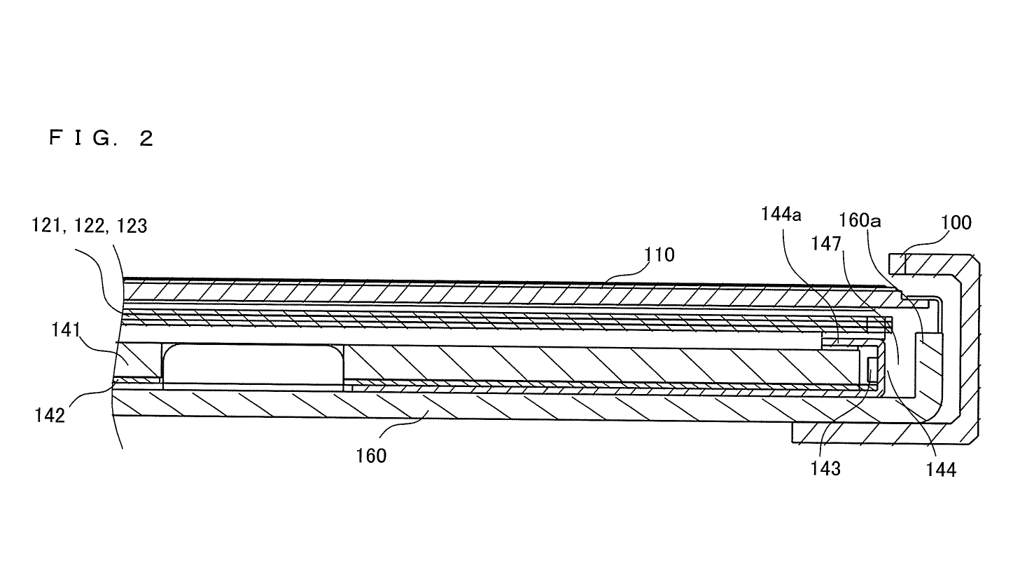

First, a liquid crystal display apparatus as an example of a display apparatus according to the present disclosure will be described. FIG. 1 is a view showing the schematic structure of a liquid crystal display apparatus 1 having a backlight device 140 using a unified-motion mechanism described later. The backlight device 140 is an example of a lighting apparatus according to the present disclosure. FIG. 2 is a view showing an A-A cross section of the liquid crystal display apparatus 1 shown in FIG. 1.

In FIG. 1, the liquid crystal display apparatus 1 has a liquid crystal panel 110 as a display portion for displaying information, the backlight device 140 which radiates illumination light to the liquid crystal panel 110, and an optical sheet 120 for uniformly diffusing light radiated from the backlight device 140, in the in-plane direction of the liquid crystal panel 110. The optical sheet 120 is composed of a diffusing sheet 121, a prism sheet 122, and a DBEF 123.

The backlight device 140 includes a light source device composed of a plurality of light emitting diodes (LEDs) 143 linearly arranged along a direction perpendicular to the drawing plane of FIG. 2, an LED board 144 which is a board on which the light emitting diodes (LEDs) 143 are mounted, a light guide plate 141 which light from the LED 143 enters and which emits the light toward the liquid crystal panel 110, and a reflection sheet 142 disposed on a side of the light guide plate 141 opposite to the liquid crystal panel 110. Here, as an example, the LED boards 144 on which the light emitting diodes (LEDs) 143 are mounted are provided at both ends (right and left ends) in the horizontal direction (right-left direction) of the backlight device 140, thus forming a backlight of edge-light type which has light sources at right and left ends. Alternatively, a backlight of edge-light type that has a light source at one of right and left ends, or a backlight of edge-light type that has a light source at one or both ends (upper and lower ends) in the perpendicular direction (vertical direction) may be formed. The placement manner of the light emitting diodes (LEDs) is not limited to linear placement, but any placement manner can be employed as long as a light exit surface of the light source device faces an entrance surface of the light guide plate described later. It is sufficient that the light source device has one or more light emitting diodes (LED).

The liquid crystal display apparatus 1 has a lower frame 160 disposed on a side of the backlight device 140 opposite to the liquid crystal panel 110, and the backlight device 140 is held by the lower frame 160. A mold frame 130 is fixed to the lower frame 160, and the optical sheet 120 is fixed to the mold frame 130. Further, movement of the liquid crystal panel 110 in the thickness direction is prevented by an upper frame 100, and the upper frame 100 is fixed to the lower frame 160.

Owing to the above configuration, the liquid crystal display apparatus 1 guides light radiated from the light emitting diode (LED) 143, to the display portion of the liquid crystal panel 110, thereby enabling display of an image.

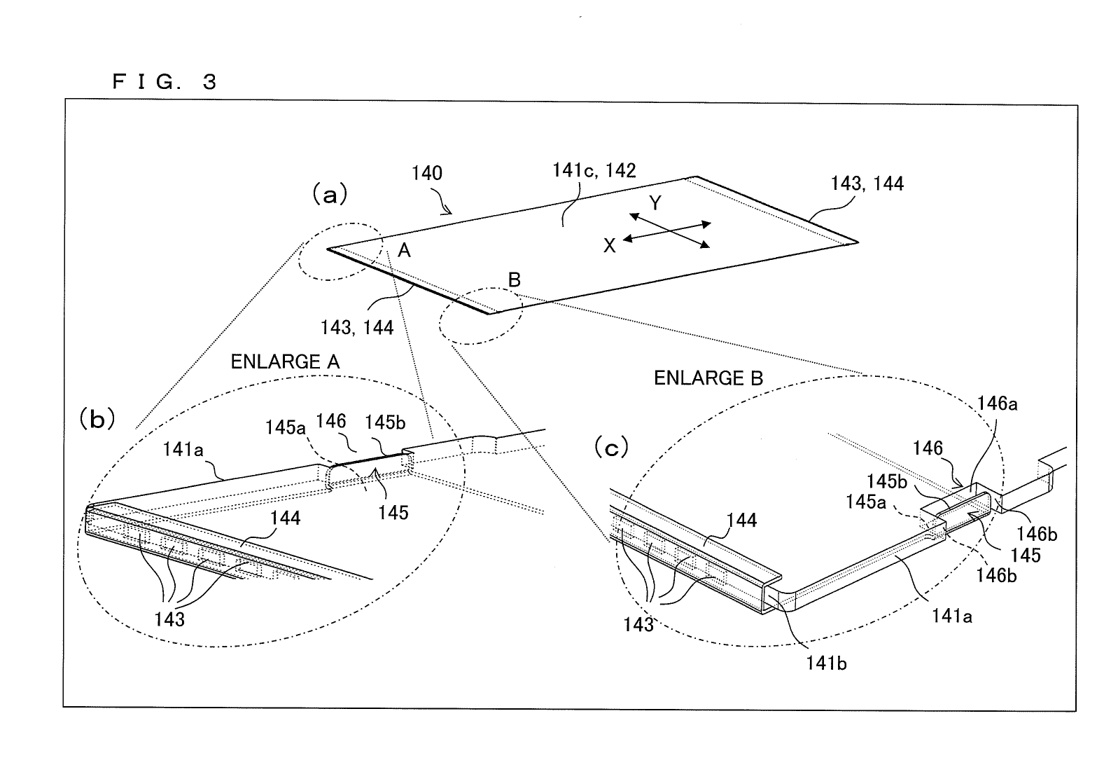

As shown in FIG. 3 described later, the light guide plate 141 has an entrance surface 141b through which light from the light emitting diode 143 enters, and a light emission surface 141c which emits light having entered through the entrance surface 141b. Thus, the light guide plate 141 guides light having entered through the entrance surface 141b, in a predetermined propagation direction and emits the light through the light emission surface 141c. The light source device has, as a whole, a light exit surface facing the entrance surface 141b of the light guide plate 141. The exit surface of each light emitting diode 143 may be parallel to the light exit surface of the light source device. Besides, even in the case where the exit surface of each light emitting diode 143 has an individual inclination, the light exit surface of the light source device facing the entrance surface 141b, that is, configured such that both surfaces face each other in parallel or substantially parallel can be defined in the sense that the light emission device as a whole causes light to enter the light guide plate 141. The following disclosure relates to keeping the inter-surface distance constant. Normally, the light guide plate 141 is formed by a resin member. Specifically, the light guide plate 141 is formed by PMMA, MS, PS, or the like. One of the features of resin members is expansion (hereinafter, thermal expansion) due to temperature increase and expansion (hereinafter, hydroscopic expansion) due to moisture absorption. As a specific example, the case of using PMMA (acrylic) will be described. In the case of a PMMA (acrylic) member with a product size of 1220 mm in the longitudinal direction and 700 mm in the short-side direction, when the temperature increases by 25 degrees and the relative humidity increases by 40%, the dimension increases by 3.9 mm in the longitudinal direction and 2.2 mm in the short-side direction.

One problem caused by dimension change in the light guide plate 141 is that the relative positions of the light emitting diode (LED) 143 and the light guide plate 141 change. In the case where the dimension change in the light guide plate 141 cannot be suppressed in terms of structure, the entrance surface 141b of the light guide plate 141 comes into contact with the light emitting diode 143, so that, in the worst case, the LED 143 is broken.

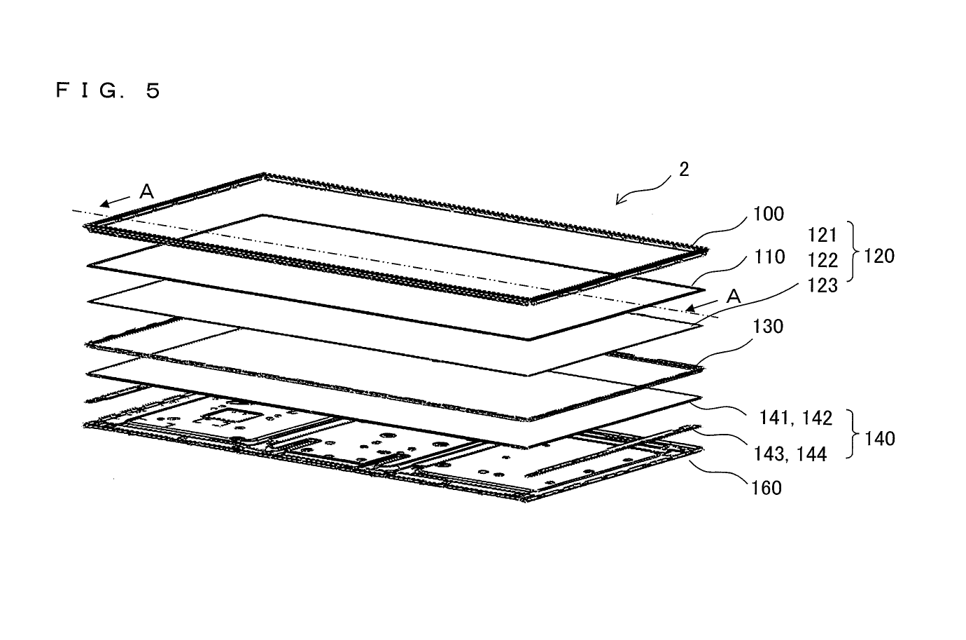

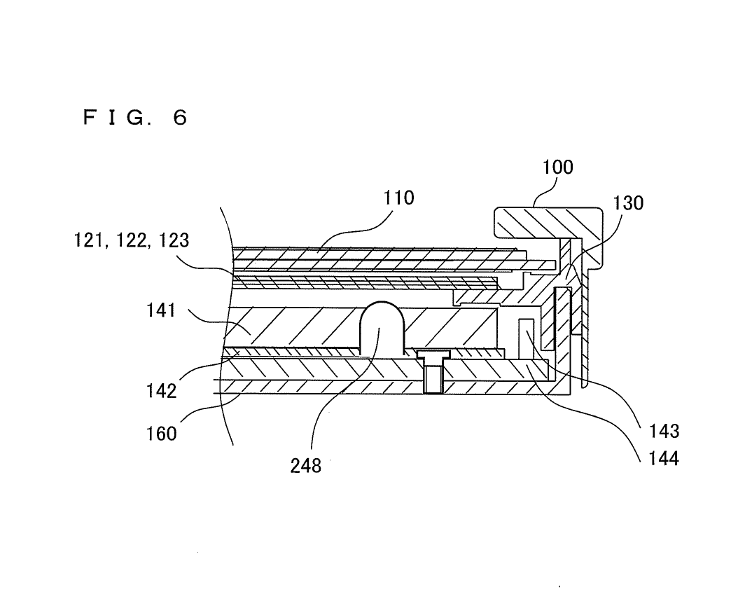

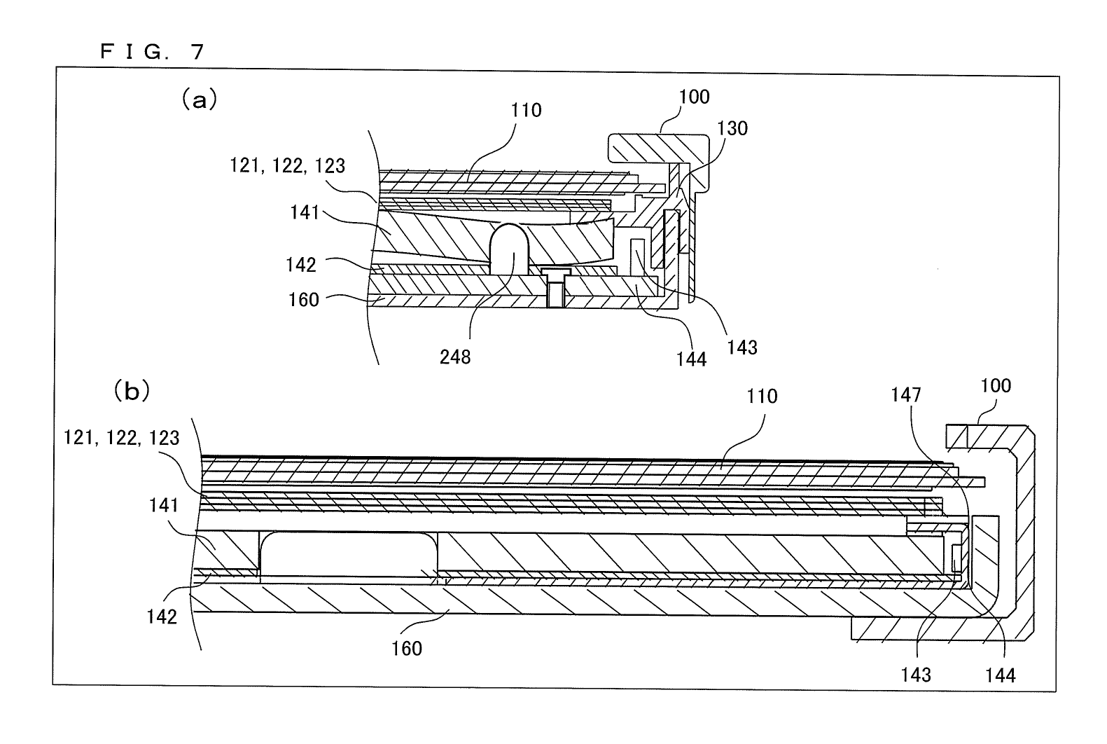

FIG. 5 is a schematic structure view showing the liquid crystal display apparatus 2 in the case of not using the unified-motion mechanism. FIG. 6 is an A-A sectional view of the liquid crystal display apparatus 2 shown in FIG. 5. (a) of FIG. 7 is a view showing the state of the light guide plate after dimension change in the case of not using the unified-motion mechanism. (b) of FIG. 7 is a view showing the state of the light guide plate after dimension change in the case of using the unified-motion mechanism. It is noted that in FIG. 5, FIG. 6, and FIG. 7, the same constituent elements as in FIG. 1 are denoted by the same reference characters, and the description thereof is omitted.

One of methods for preventing breakage of the LED 143 due to dimension change in the light guide plate 141 without using the configuration of the present disclosure is to provide a light guide plate expansion suppressing pin 248 in the vicinity of the light emitting diodes 143, thereby mechanically suppressing dimension change in the light guide plate 141 in a direction toward the light emitting diodes (LEDs) 143.

However, the method using the light guide plate expansion suppressing pin 248 cannot absorb dimension change in the plane direction due to temperature increase or moisture absorption in the light guide plate 141, so that the light guide plate 141 is bent up in the thickness direction as shown in (a) of FIG. 7 and comes into contact with the optical sheet 120 or the liquid crystal panel 110, whereby luminance unevenness and color unevenness can occur.

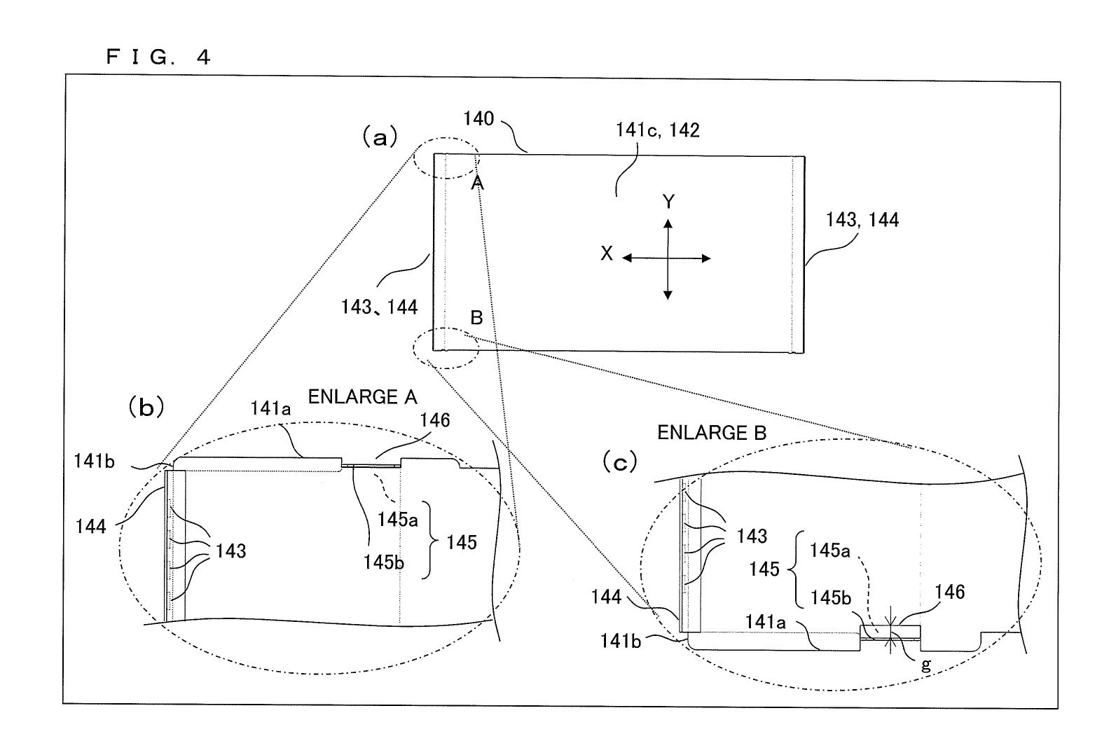

FIG. 3 and FIG. 4 are a perspective view and a plan view showing a specific structure of the backlight device 140 in the case of using the configuration of the present disclosure. (a) of FIG. 3 and (a) of FIG. 4 show a region A and a region B in which jointing portions 145 are provided, in the entire light source unit. The region A is an upper left region of the light source unit, and the region B is a lower left region of the light source unit. (b) of FIG. 3 and (b) of FIG. 4 show the detailed structure in the region A. (c) of FIG. 3 and (c) of FIG. 4 show the detailed structure in the region B. In addition, as shown in (a) of FIG. 3 and (a) of FIG. 4, on the device plane, the longitudinal direction is set as a horizontal direction X, and the short-side direction perpendicular to the longitudinal direction is set as a vertical direction Y.

In the present disclosure, as shown in FIG. 3 and FIG. 4, the light guide plate 141 has depressed portions 146 on side surfaces (non-entrance surfaces) 141 a different from the entrance surface 141b through which light radiated from the LED143 enters, and the LED board 144 on which the light emitting diodes (LEDs) 143 are mounted has the jointing portions 145 formed in L shape so as to be jointed to the light guide plate depressed portion 146. As shown in (b) and (c) of FIG. 3 and (b) and (c) of FIG. 4, each depressed portion 146 is a cutout formed by cutting the side surface 141a toward the inside of the light guide plate 141. The depressed portion 146 is an engaged portion with which the jointing portion 145 is engaged, whereby the LED board 144 is engaged with the light guide plate 141. A backmost surface 146a of the depressed portion 146 is a surface obtained by a part of the side surface 141a receding toward the inside, and the depressed portion 146 has a rectangular shape in a plan view. The L shape of the jointing portion 145 is formed by a base portion 145a which is a part of the LED board 144, and a wall plate portion 145b standing in the thickness direction of the light guide plate 141 from the base portion 145a. The standing height of the wall plate portion 145b can be freely set. The entirety of a surface of the light guide plate 141, facing an inner side surface of the wall plate portion 145b corresponds to the backmost surface 146a of the depressed portion 146. In addition, as shown in (b) of FIG. 3 and (b) of FIG. 4, at the depressed portion 146 (hereinafter, referred to as “one depressed portion 146”) formed on one side surface 141a, the jointing portion 145 is provided such that an inner side surface of the wall plate portion 145b is in contact with the backmost surface 146a of the one depressed portion 146, and such that both side surfaces of the wall plate portion 145b are in contact with both side surfaces 146b and 146b of the one depressed portion 146. In addition, as shown in (c) of FIG. 3 and (c) of FIG. 4, at the depressed portion 146 (hereinafter, referred to as “the other depressed portion 146”) formed on the other side surface 141a, the jointing portion 145 is provided such that an inner side surface of the wall plate portion 145b is separated by a gap g from the backmost surface 146a of the other depressed portion 146, and such that both side surfaces of the wall plate portion 145b are in contact with both side surfaces 146b and 146b of the other depressed portion 146. Thus, the jointing portions 145 are engaged with the respective depressed portions 146 to be combined.

The light guide plate 141 expands to have respective components in the horizontal direction X and the vertical direction Y, due to temperature increase or moisture absorption. Here, it is assumed that expansion in the thickness direction of the light guide plate 141 is extremely small. In the above structure, regarding the LED board 144, when the dimension of the light guide plate 141 changes due to temperature increase or moisture absorption, the jointing portion 145 is pressed by the depressed portion 146 of the light guide plate 141 in substantially the same direction as the normal direction (horizontal direction X) of a surface on which the light emitting diodes (LEDs) 143 are mounted. At this time, since the LED board 144 is located at an end in the horizontal direction X of the backlight device 140, the wall plate portion 145b of the jointing portion 145 is pressed by the depressed portion 146 due to expansion toward the left end in the case where the wall plate portion 145b is located at the left end, and is pressed by the depressed portion 146 due to expansion toward the right end in the case where the wall plate portion 145b is located at the right end. Since the expansion difference between both side ends of the depressed portion 146 is small enough to ignore, the length in the horizontal direction X of the depressed portion 146 remains substantially constant between before and after the expansion. Therefore, during expansion, the relative positional relationship in the horizontal direction between the other depressed portion 146 and the jointing portion 145 can be kept substantially constant. Thus, here, the engaged portion is provided at a side close to the entrance surface 141a of the light guide plate 141, as seen from the facing direction, so that dimension change of the engaged portion hardly occurs in the facing direction during expansion or contraction of the light guide plate 141. Thus, change in efficiency of light entry from the light source device to the light guide plate 141 is prevented. Owing to the above press, the LED board 144 can be carried in the plane direction by an amount that is substantially the same as a dimension change amount of the light guide plate 141 (hereinafter, the above configuration is referred to as a unified-motion mechanism). Therefore, if a clearance 147 between a side surface 160a of the lower frame and the LED board 144 is secured so as to be larger than the dimension change amount of the light guide plate 141, the relative positional relationship between the entrance surface 141b of the light guide plate 141 and the light emitting diode (LED) 143 can be always kept constant irrespective of dimension change in the light guide plate 141, as shown in (b) of FIG. 7. Specifically, in the case of using PMMA (acrylic) as a material for the light guide plate 141, since dimension change in the longitudinal direction is 3.9 mm, if the clearances 147 are provided on both of the right and left sides of the liquid crystal display apparatus 1, the required clearance amount is equal to or greater than ½ of 3.9 mm, that is, 1.95 mm. On the other hand, when the light guide plate 141 is contracted due to temperature decrease or moisture discharge after expansion, motion in a direction opposite to the above case occurs. In this case, by the same principle, the relative positional relationship between the entrance surface 141b of the light guide plate 141 and the light emitting diodes (LEDs) 143, that is, the inter-surface distance between the light exit surface of the light source device having the plurality of light emitting diodes (LEDs) 143 and the entrance surface 141b of the light guide plate 141 is kept constant. As described above, the jointing portion 145 which is a part of the LED board 144 is an engagement member fixed to the LED board 144 and engaging the LED board 144 with the light guide plate 141. The jointing portion 145 prevents relative motion between the LED board 144 and the engaged portion of the light guide plate 141 in a direction in which the light exit surface of the light source device and the entrance surface 141b of the light guide plate 141 face each other. Owing to the prevention of the relative motion between the LED board 144 and the engaged portion, at a part where the LED board 144 and the light guide plate 141 are integrated as a unit including the engaged portion, the LED board 144 is regarded as making no motion relative to the light guide plate 141 during expansion or contraction of the light guide plate 141.

In addition, for expansion in the vertical direction Y of the light guide plate 141, at the other depressed portion 146, the gap g having an interval g from the wall plate portion 145b of the jointing portion 145 is provided. Therefore, if the gap g is set such that the expansion amount of the light guide plate 141 in the vertical direction Y is equal to or smaller than the gap g, relative motion between the LED board 144 and the light guide plate 141 in the vertical direction Y is tolerated within the gap g. Therefore, the light guide plate 141 can be prevented from being distorted by the backmost surface 146a of the other depressed portion 146 colliding with the jointing portion 145 due to expansion of the light guide plate 141 in the vertical direction Y. Therefore, instead of being completely fastened to both side surfaces 146b and 146b of the other depressed portion 146, the wall plate portion 145b of the jointing portion 145 is provided so as to be slidable on both side surfaces 146b and 146b, so that the other depressed portion 146 can smoothly move in the gap g during expansion of the light guide plate 141 or contraction after the expansion. In this sense, the jointing portion 145 may be engaged so as to be freely fitted into the other depressed portion 146 with a slight play from both side surfaces 146b and 146b thereof, and such a structure also can keep substantially constant the relative positional relationship between the other depressed portion 146 and the jointing portion 145 in the horizontal direction X during expansion or contraction of the light guide plate 141 in the horizontal direction X. It is noted that the one depressed portion 146 has a structure that the inner side surface of the wall plate portion 145b of the jointing portion 145 is in contact with the backmost surface 146a of the one depressed portion 146. For example, such an engaged portion with no gap g can be provided at a reference position in the display apparatus, where the positional relationship between the LED board 144 and the light guide plate 141 in the vertical direction Y is not to be changed, or the like. As in the case of the jointing portion 145 at the other depressed portion 146, a gap g (which may not have the same value of the gap g at the other depressed portion 146) may be provided.

It is noted that the LED board 144 is made from a bendable board. Specifically, an aluminum board obtained by pasting polyimide on aluminum and then forming a wiring pattern of copper foil on the polyimide, can be used. In the case where an insulation layer on the aluminum is formed by polyimide, breakage such as flaw or crack hardly occurs in the insulation layer when the aluminum board is bent.

The unified-motion mechanism makes it possible to prevent breakage of the light emitting diode (LED) 143 without using the light guide plate expansion suppressing pin 248.

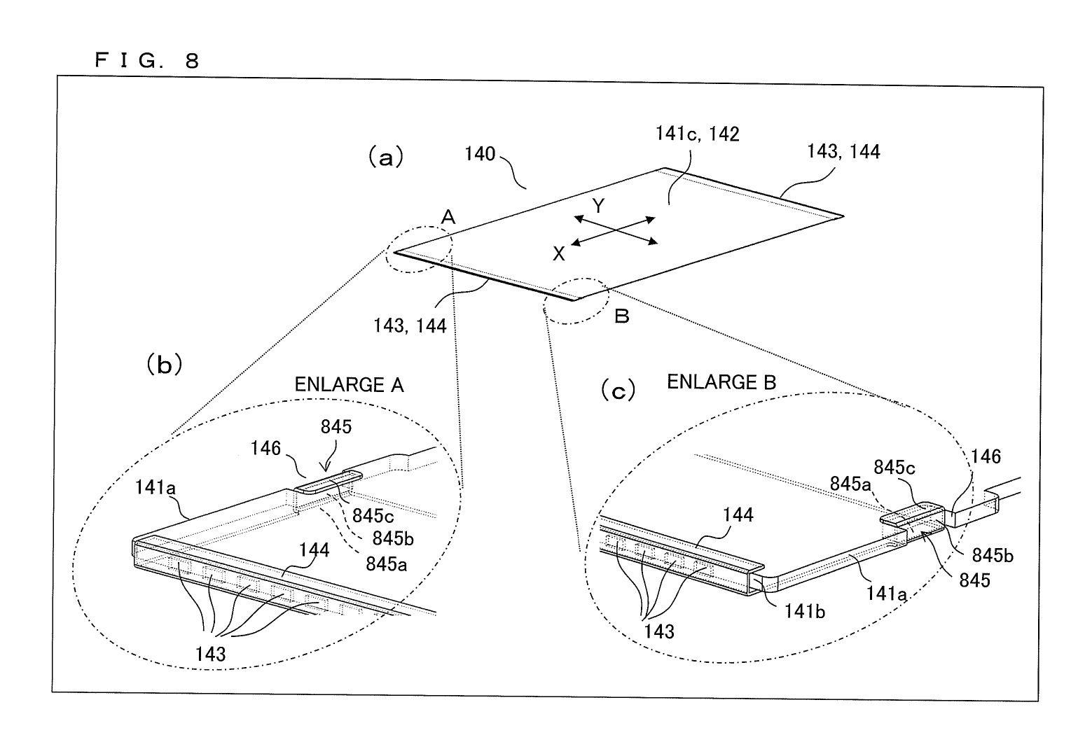

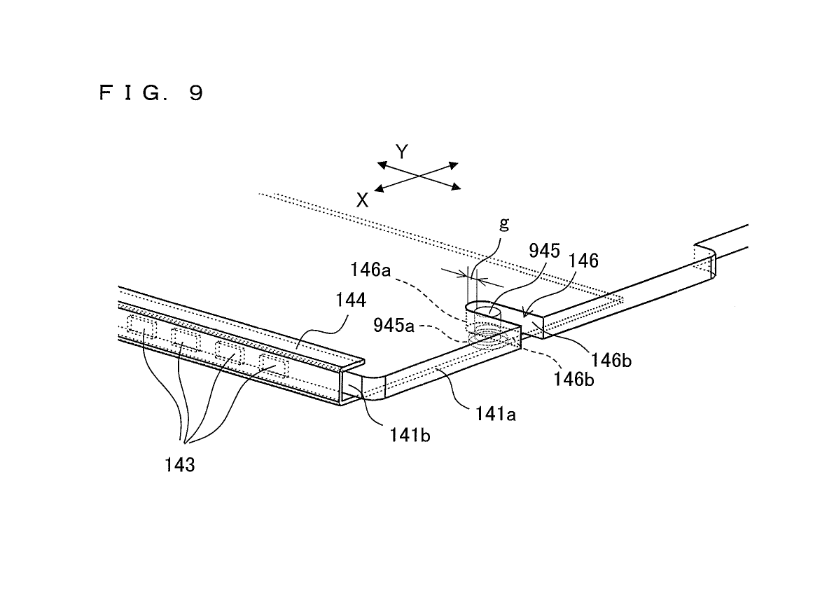

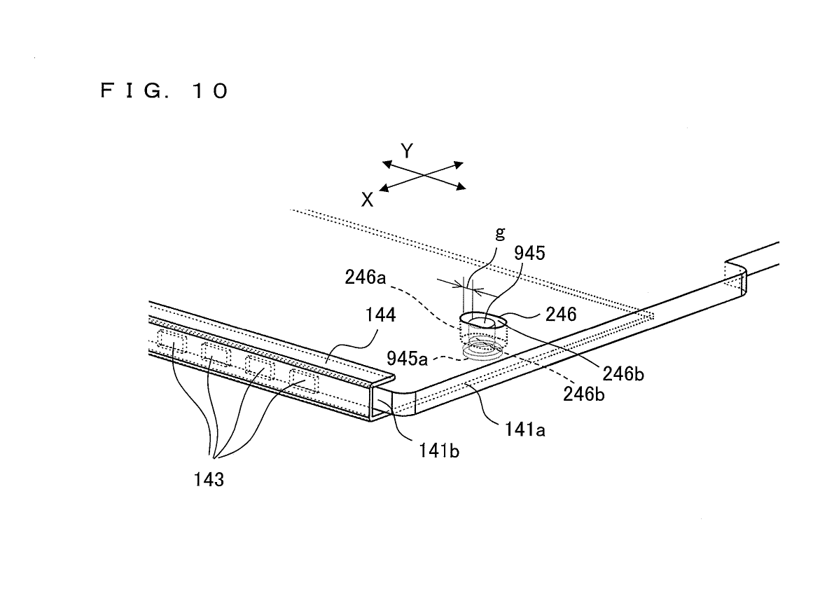

FIG. 8, FIG. 9, and FIG. 10 are views showing modifications of the present disclosure. It is noted that in FIG. 8, FIG. 9, and FIG. 10, the same constituent elements as in FIG. 1 are denoted by the same reference characters, and the description thereof is omitted.

In the above example of the present disclosure, the jointing portion 145 of the LED board is formed in L shape so as to be parallel to the non-entrance surface 141a of the light guide plate 141. Instead, the jointing portion 145 may be a jointing portion 845 having a U shape as shown in FIG. 8. The U shape is such that, for example, a wall plate portion 845b whose standing height is set to correspond to the thickness of the light guide plate 141 is provided standing from a base portion 845a which is similar to the base portion 145a of the L-shaped jointing portion 145 shown in FIG. 3 and FIG. 4, and an upper plate portion 845c parallel to the plate surface of the light guide plate 141 is connected to an upper end of the wall plate portion 845b. The upper plate portion 845c of the jointing portion 845 extends over an upper surface of the light guide plate 141 from the upper end of the wall plate portion 845b. Thus, the jointing portion 845 is engaged with the depressed portion 146 so as to hold the light guide plate 141 by the U shape. (a) of FIG. 8 shows a region A and a region B in which the jointing portions 845 are provided, in the entire light source unit. The region A is an upper left region of the light source unit, and the region B is a lower left region of the light source unit. As shown in (b) of FIG. 8, at one depressed portion 146 provided in the region A, the jointing portion 845 is provided such that an inner side surface of the wall plate portion 845b is in contact with the backmost surface 146a of the one depressed portion 146. As shown in (c) of FIG. 8, in the region B, the jointing portion 845 is provided such that an inner side surface of the wall plate portion 845b is separated by a gap g from the backmost surface 146a of the other depressed portion 146, as in (c) of FIG. 3 and (c) of FIG. 4. During expansion or contraction of the light guide plate 141, behavior in the horizontal direction X is the same as in the case of FIG. 3 and FIG. 4, and behavior in the vertical direction Y is such that an upper surface of the light guide plate 141 slides on a lower surface of the upper plate portion 845c of the jointing portion 845. It is noted that at the one depressed portion 146, a gap g (which may not have the same value of the gap g at the other depressed portion 146) may be provided as in the case of the jointing portion 845 of the other depressed portion 146.

As shown in FIG. 9, the depressed portion 146 may be formed as a cutout such that the backmost surface 146a has a semicylinder-surface shape with its axis direction being the thickness direction of the light guide plate 141, and a jointing portion 945 formed as a pin may be engaged with the depressed portion 146. For example, the jointing portion 945 has a flange 945a at its one end, and is configured to pass through the LED board 144 from the back surface side and to be in contact with both side surfaces 146b and 146b of the depressed portion 146. The flange 945a may be fixed on the back surface side of the LED board 144, or a thread may be formed on a side surface of the pin so that the pin is screwed and fit into a screw hole of the LED board 144. Alternatively, without the flange 945a, a boss-like pin may be provided standing from the LED board 144. In the depressed portion 146, a side surface of the jointing portion 945 is separated from the backmost surface 146a by a gap g as measured in the vertical direction Y. Although FIG. 9 shows a part corresponding to the other depressed portion 146, also a part corresponding to the one depressed portion 146 can be configured in the same manner, or can be configured such that, instead of providing the gap g, the jointing portion 945 is provided in contact with the backmost surface 146a, in the depressed portion 146. The backmost surface 146a of the depressed portion 146 is not limited to a cylindrical surface but may be a flat surface or any other curved surface. In addition, the shape of the pin located in the depressed portion 146 is not limited to a cylindrical shape but may be a prism or any other shape.

As shown in FIG. 10, in the light guide plate 141, a hole 246 having an oval shape elongated in the vertical direction Y in a plan view may be provided as an engaged portion, and the same jointing portion 945 as described in FIG. 9 may be passed through the LED board 144 from the back surface side so as to be engaged with the hole 246. The jointing portion 945 is in contact with both side surfaces 246b and 246b which define the range in the horizontal direction X, of the depressed portion 146. In addition, a side surface of the jointing portion 945 is separated by a gap g as measured in the vertical direction Y from, of two side surfaces that confine the range in the vertical direction Y and form the semicylinder-surface shape, a side surface 246a that is farther from the side surface 141a of the hole 246. The side surface of the jointing portion 945 may be in contact with or be separated from the other one of the side surfaces that define the range in the vertical direction Y. Although FIG. 10 shows the region B, the same configuration can be applied also in the region A. For both holes 246 and 246, gaps g corresponding to expansion in the vertical direction Y of the light guide plate 141 are provided. The side surfaces that define the range in the vertical direction Y, of the hole 246, is not limited to a semicylinder-surface shape but may be a flat plane or any other shape as long as a gap g is formed so that the light guide plate 141 can make a motion in the vertical direction Y during expansion or contraction.

Besides the above effects, the present disclosure can solve other problems of the conventional liquid crystal display apparatus. The conventional liquid crystal display apparatus has a problem that a part directly above the light emitting diodes (LEDs) 143 has a greater luminance than the other part of the liquid crystal display apparatus (hereinafter, referred to as a bright line problem). In the present disclosure, as shown in FIG. 2, an extended portion 144a of the LED board 144, which is formed by, for example, folding a part of the LED board 144, covers a part directly above the light emitting diodes (LEDs) 143, so as to block light, thereby reducing the bright line problem that could occur directly above the light emitting diodes (LEDs) 143. This copes with such a situation that in FIG. 2, if the extended portion 144a is not provided, light emitted from the light emitting diodes (LEDs) 143 leaks to the outside of the entrance surface 141b of the light guide plate 141. Thus, unnecessary light emitted not via the light guide plate 141 is prevented from diffusing upward in the backlight device and causing luminance unevenness, and usage efficiency of light emitted from the light emitting diodes (LEDs) 143 can be enhanced. In addition, since the extended portion 144a as a light blocking member is carried as a part of the LED board 144 during expansion or contraction in the horizontal direction X of the light guide plate 141, it is not necessary to adjust the position of the light blocking member in accordance with deformation of the light guide plate 141. In addition, the extended portion 144a can be formed by merely bending the LED board 144 into an L shape or the like, and therefore such a process of separately pasting a light blocking member to the LED board 144 is not needed.

As described above, in the liquid crystal display apparatus 1 shown in the present disclosure, when dimension change in the light guide plate 141 occurs due to temperature increase or moisture absorption, the LED board 144 on which the light emitting diodes (LEDs) 143 are mounted can be carried by the same amount as the dimension change amount of the light guide plate, whereby the relative positional relationship between the entrance surface 141b of the light guide plate 141 and the light emitting diodes (LEDs) 143 can be maintained.

Instead of using the light guide plate expansion suppressing pin 248 as shown in (a) of FIG. 7, it is also conceivable to merely increase the distance between the exit surface of the light emitting diode and the entrance surface of the light guide plate, thereby solving a problem that the light emitting diode is destroyed due to expansion of the light guide plate, or thereby decreasing the rate of change in the relative positions of the exit surface of the light emitting diode and the entrance surface of the light guide plate and solving the luminance unevenness. However, in such a method, of light emitted from the light emitting diode, the amount of light entering the entrance surface of the light guide plate decreases, so that light usage rate reduces. If the light emission amount of the light emitting diode is increased in order to compensate for the decrease in the light amount, power consumption or heat generation increases. In the case where a large amount of light deviates to the outside of the entrance surface of the light guide plate, the above-described bright line problem could be encouraged. In addition, if a member for converging light emitted from the light emitting diode is provided between the exit surface of the light emitting diode and the entrance surface of the light guide plate in order to compensate for the reduction in the light usage rate, the configuration is complicated, so that a component placing process is complicated and the cost increases. In recent years, it is increasingly desired to slim the frame of the display apparatus, and the distance between the exit surface of the light emitting diode and the entrance surface of the light guide plate is being more and more reduced. Therefore, the structure for keeping constant the relative positional relationship between the entrance surface 141b of the light guide plate 141 and the light emitting diodes (LEDs) 143 as described above is advantageous for meeting the desire to slim the frame.

In the present disclosure, the case of using PMMA (acrylic) as a material for the light guide plate 141 has been described as an example. However, the material for the light guide plate is not limited to PMMA (acrylic). The present disclosure is effective even in the case of using PS (polystyrene) or MS (poly methacryl styrene). In the case of using a material other than PMMA (acrylic) for the light guide plate 141, a different clearance 147 may be used in accordance with the rate of dimension change in the light guide plate 141 made of each material.

In the above description, the LED board 144 is an aluminum board. However, the LED board 144 is not limited to an aluminum board as long as the board can be bent. Specifically, it is conceivable that, giving priority to bending property, stainless steel is used instead of aluminum.

In the above description, the optical sheet 120 is composed of the diffusing sheet 121, the prism sheet 122, and the DBEF 123. However, the configuration of the optical sheet 120 is not limited to these three elements. Specifically, the optical sheet 120 may be composed of only the diffusing sheet 121 and the prism sheet 122. As long as the optical characteristic is ensured, the optical sheet 120 may be composed of only one diffusing sheet 121.

In the present disclosure, the case of a liquid crystal television has been described. However, the lighting apparatus of the present disclosure is not limited thereto. The lighting apparatus of the present disclosure can be suitably used for a display apparatus using a light guide plate. Specific examples include a liquid crystal monitor, a mobile phone, an interactive whiteboard, electronic advertisement, and the like.

While the disclosure has been described in detail, the foregoing description is in all aspects illustrative and not restrictive. It will be understood that numerous other modifications and variations can be devised without departing from the scope of the disclosure.

### INDUSTRIAL APPLICABILITY

The display apparatus according to the present disclosure can always keep constant the relative positional relationship between the light guide plate and the light emitting diode, thus providing a liquid crystal display apparatus with high reliability that can absorb dimension change in the light guide plate.

### Description of the Reference Characters

1 liquid crystal display apparatus with unified-motion mechanism
2 liquid crystal display apparatus without unified-motion mechanism
100 upper frame
110 liquid crystal panel
120 optical sheet
121 diffusing sheet
122 prism sheet
123 DBEF
130 mold frame
140 backlight device (light source unit) with unified-motion mechanism
141 light guide plate
141a side surface (non-entrance surface)
141b entrance surface
141c light emission surface
142 reflection sheet
143 light emitting diode (LED)
144 LED board
144a extended portion
145 jointing portion
145a base portion
145b wall plate portion
146 depressed portion
146a backmost surface
146b side surface
147 clearance
160 lower frame
160a lower frame side surface
246 hole
246a side surface
246b side surface
248 light guide plate expansion suppressing pin
845 jointing portion
845a base portion
845b wall plate portion
845c upper plate portion
945 jointing portion
945a flange
g gap
X horizontal direction
Y vertical direction

What is claimed is:

1. A lighting apparatus comprising:
a light source device having one or more light emitting diodes;
a board on which the light source device is provided;
a light guide plate having an entrance surface facing a light exit surface of the light source device via a given distance such that light emitted from the light exit surface of the light source device enters the entrance surface, and a light emission surface which emits the light having entered through the entrance surface, the light guide plate configured to propagate the light having entered through the entrance surface and emit the light through the light emission surface; and
an engagement member fixed on the board and engaging the board with the light guide plate, the engagement member configured to prevent relative motion, between the board and an engaged portion of the light guide plate engaged with the board, in a direction in which the light exit surface of the light source device and the entrance surface of the light guide plate face each other,
wherein the engaged portion of the light guide plate is located at only two portions at a side close to the entrance surface of the light guide plate, as seen from the facing direction.

2. The lighting apparatus according to claim 1, wherein the engagement member is a part of the board, that is engaged with a cutout formed in the light guide plate.

3. The lighting apparatus according to claim 1, wherein the engagement member is a pin that is engaged with a cutout or a hole formed in the light guide plate.

4. The lighting apparatus according to claim 1, wherein the board has a portion that covers an interspace between the light exit surface of the light source device and the entrance surface of the light guide plate from a front surface side.

5. The lighting apparatus according to claim 1, wherein the engagement member is located separately from the light guide plate by a gap provided at the engaged portion in a direction perpendicular to the facing direction on a plane of the light guide plate, the gap affording relative motion between the board and the light guide plate in the perpendicular direction within the gap.

6. The lighting apparatus according to claim 1, wherein the board is a board formed by laminating a polyimide layer and a copper foil, in this order, on an aluminum substrate.

7. A display apparatus comprising the lighting apparatus according to claim 1.
